(19) United States
(12) Patent Application Publication
(10) Pub. No.: US 2025/0242314 A1
(43) Pub. Date: Jul. 31, 2025

(54) MAGNETOPHORETIC MEMBRANE FABRICATION PROCESS WITH NANOMATERIALS FOR HIGH PERFORMANCE TUNABLE SELECTIVE MEMBRANES

(71) Applicant: University of North Dakota, Grand Forks, ND (US)

(72) Inventors: Musabbir Jahan Talukder, Grand Forks, ND (US); Ali Alshami, Grand Forks, ND (US)

(21) Appl. No.: 19/041,385

(22) Filed: Jan. 30, 2025

Related U.S. Application Data
(60) Provisional application No. 63/626,801, filed on Jan. 30, 2024.

(51) Int. Cl. B01D 71/68; B01D 71/02

(52) U.S. Cl. CPC B01D 71/68; B01D 71/0211; B01D 2325/46

(57) ABSTRACT

A separation membrane includes a polymer and a plurality of nanoparticles having magnetic properties when placed in an external magnetic field, the relative arrangement of the plurality of nanoparticles determining the selectivity of the separation membrane. A method of fabricating a separation membrane includes intercalating a plurality of nanoparticles with paramagnetic or magnetic ions or molecules to produce intercalated nanoparticles having magnetic properties, depositing a solution of the plurality of intercalated nanoparticles on a support, applying an external magnetic field to the deposited solution of intercalated nanoparticles, and drying the solution of intercalated nanoparticles.

### CROSS-REFERENCE TO RELATED APPLICATION(S)

This application claims the benefit of U.S. Provisional Application No. 63/626,801 filed Jan. 30, 2024 for “MAGNETOPHORETIC MEMBRANE FABRICATION PROCESS WITH 2D NANOMATERIALS FOR HIGH PERFORMANCE TUNABLE SELECTIVE MEMBRANES” by M. J. Talukder and A. Alshami.

### STATEMENT OF GOVERNMENT INTEREST

This invention was made with government support under Grant No. NSF 2327908 awarded by the National Science Foundation. The government has certain rights in the invention.

### BACKGROUND

The present disclosure is related generally to separation membranes and, more particularly, to tunable selective separation membranes and the fabrication thereof.

Membranes are used for the physical separation of gas and liquid mixtures and are an essential component in a wide range of applications from purifying natural gas and providing clean drinking water to dialysis for patients with kidney failure. Separation membranes separate molecules based on a solution-diffusion or size exclusion principle and are applicable to liquids, gases, and liquid-gas mixtures. Most separation membranes today are formed from polymeric or mixed-matrix materials (MMM), which exhibit a trade-off between permeability and selectivity. Polymer and MMM membranes with high permeability or high permeation rates generally have poor selectivity, allowing undesirable substances to pass through. On the other hand, separation membrane materials that provide high selectivity suffer from low permeability, necessitating increased energy inputs to improve permeation rates. Selectivity is based on the properties of the polymer or the dispersed material. There is currently no membrane material matrix that can be tuned for selectivity of different molecules or molecule combinations to be separated. As such, a wide variety of polymer or MMM membranes have been developed for different applications. Furthermore, no polymer or MMM membrane material offers perfectly uniform pore distribution or selectivity control at the nanoscale, which is a critical challenge in gas separation of near similar radii molecules.

### SUMMARY

A separation membrane includes a polymer and a plurality of nanoparticles having magnetic properties when placed in an external magnetic field, the relative arrangement of the plurality of nanoparticles determining the selectivity of the separation membrane.

A method of fabricating a separation membrane includes intercalating a plurality of nanoparticles with paramagnetic or magnetic ions or molecules to produce intercalated nanoparticles having magnetic properties, depositing a solution of the plurality of intercalated nanoparticles on a support, applying an external magnetic field to the deposited solution of intercalated nanoparticles, and drying the solution of intercalated nanoparticles.

The present summary is provided only by way of example, and not limitation. Other aspects of the present disclosure will be appreciated in view of the entirety of the present disclosure, including the entire text, claims and accompanying figures.

### BRIEF DESCRIPTION OF THE DRAWINGS

FIG. 1 is a flowchart of a method for forming a separation membrane.

FIG. 2 is a schematic illustration of a method of tuning a separation membrane for a desired selectivity.

While the above-identified figures set forth embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps and/or components not specifically shown in the drawings.

### DETAILED DESCRIPTION

The present disclosure is directed to the fabrication of separation membranes with tunable selectivity for separation of a specific molecule or combinations of molecules of interest. Specifically, the present disclosure is directed to the fabrication of magnetophoretic separation membranes. The disclosed membrane fabrication process utilizes magnetized nanoparticles to produce highly controlled and selective membranes for a wide range of applications. During fabrication, a variable magnetic field can be applied to manipulate the spacing and alignment of paramagnetic nanoparticles to finely control or tune the selectivity of the fabricated membranes. Under a magnetic field, the disclosed paramagnetic nanoparticles can become magnetized, behaving like nanomagnets, and align themselves at consistent distances determined by the strength of the external magnetic field. This alignment and controlled spacing results in interparticle gaps that act as selective channels, capable of effectively filtering out undesirable molecules. The disclosed tunable separation membranes are usable with liquids, gases, and liquid-gas mixtures.

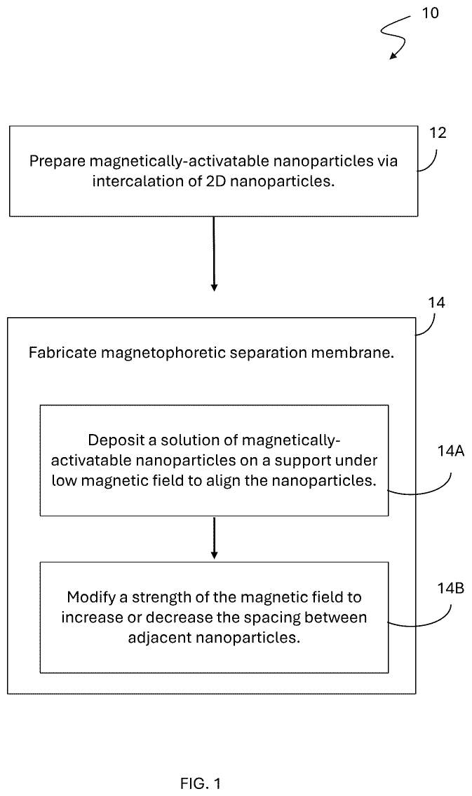

FIG. 1 is a flowchart of method 10 for fabricating a separation membrane with tunable selectivity. The separation membrane comprises a plurality of nanoparticles that have been aligned and spaced to enable separation of molecules of a desired size. The nanoparticles can be two-dimensional or generally planar, defined primarily by length and width as further described herein. Suitable nanoparticle materials can be magnetized and arranged under an external magnetic field to provide a desired pore size for selective material separation.

In step 12, nanoparticles are modified through a process of intercalation to produce nanoparticles with magnetic properties. Suitable nanoparticle materials include, for example, graphene oxide and MXenes. Graphene oxide nanoparticles can include a plurality of graphene oxide monolayers provided in a stacked arrangement. Graphene oxide nanoparticles can include sheets of at least two stacked monolayers. In some embodiments, graphene oxide nanoparticles can include sheets of 2 to 6 stacked monolayers. In some embodiments, graphene oxide nanoparticles can include sheets of greater than 6 stacked monolayers. MXenes are organic compounds that consist of atomically thin layers of transition metal carbides, nitrides, or carbonitrides. MXenes can also be provided in multilayer stacked configurations. Nanoparticles of a desired size (i.e., length, width, and thickness or number of layers) can be provided using methods known in the art. Both graphene oxide and MXenes are hydrophilic, which allows them to be dispersed in aqueous solutions.

The nanoparticles can be swelled by hydration and intercalated with desired ions or paramagnetic materials to produce paramagnetically active 2D nanomaterials. Swelling temporarily increases a distance between nanoparticle sheets or monolayers thereby expanding the structure of the nanoparticles and allowing ions or molecules to migrate into the space between layers. Swelling can be conducted in an aqueous solution at a defined temperature, for example, 45-55° C.

In an ion intercalation process, swelling can be conducted in an ion salt solution. In this process, the ions are chemically cross-linked with the nanoparticles and, upon drying, are retained within the nanoparticle lattice. The dried nanoparticles can be washed to remove the remaining ion solution and any ions deposited on the surface of the nanoparticles. Ions that are cross-linked are retained with washing. The resulting nanoparticles are paramagnetically active, demonstrating magnetically induced properties, and are stable.

Suitable ions for inducing magnetic properties include, for example, elements with partially filled 4f and 4d orbitals, which manipulate the electron cloud of the carboxylic carbon of the graphene oxide and induce paramagnetism. Elements with partially filled 4f and 4d orbitals include, for example, holmium and yttrium. Both holmium and yttrium ions can chemically cross-link with the nanoparticles and have been demonstrated to induce paramagnetic properties. Other elements having a partially filled 4th orbital may be suitable.

In other embodiments, nanoparticles can be magnetized by intercalation with paramagnetic materials. For example, graphene oxide can be intercalated with Fe₃O₄.

The paramagnetic nanoparticles formed via ion intercalation or intercalation of paramagnetic materials can be aligned when placed in an external magnetic field. The magnetic properties of the intercalated nanoparticles increase with increased ion or paramagnetic material loading. In one non-limiting embodiment, graphene oxide was intercalated with holmium ions to produce paramagnetic graphene oxide nanoparticles. Graphene oxide was mixed with holmium salt with a graphene oxide to holmium ion molar ratio varying from 1:1 to 1:10.

In step 14, the paramagnetic nanoparticles are used to fabricate a magnetophoretic separation membrane. The paramagnetic nanoparticles can be mixed with a polymer and solvent to form a magnet-activatable nanoparticle solution that can be formed into a thin film membrane comprising the paramagnetic nanoparticles disposed in a polymer matrix. During fabrication, the polymer acts as a dispersion medium and provides mobility to the paramagnetic nanoparticles. The polymer can help maintain an interparticle distance (limiting aggregation) and can allow for controlled migration of the paramagnetic nanoparticles when placed in the external magnetic field and with increasing magnetic field. Polymers suitable for forming the separation membrane can have no selectivity, meaning they can allow all gases and/or molecules of interest to pass through, or can have selectivity that does not contribute to separation of the molecule or combination of molecules of interest. As such, separation can be based solely on the arrangement of the intercalated nanoparticles in the separation membrane. Suitable polymers include gas permeable polymers, including but not limited to, polysulfone, Matrimid 5218, BisAPAF and other polyimides.

Particle loading may vary according to application. In some non-limiting embodiments, a volume fraction of paramagnetic graphene oxide nanoparticles in a polysulfone polymer ranged from 0.1 to 0.5. In some embodiments, the volume fraction of the paramagnetic nanoparticles may be less than 0.1 or greater than 0.5. Undesirable aggregation of the paramagnetic nanoparticles can occur with higher particle loading.

The separation membrane can be formed, for example, by drop casting or other thin film membrane fabrication methods known in the art, including but not limited to vacuum deposition or spray coating. The paramagnetic nanoparticle solution can be spread over a support and allowed to dry under controlled temperature, pressure, and magnetic flux as discussed further herein. Solvent selection can be based on a desired evaporation rate and/or viscosity. As discussed further herein, fabrication is conducted in a magnetic field to align and control spacing of the paramagnetic nanoparticles. The evaporation rate of the solvent and viscosity of the solvent or solution are important parameters in the fabrication process. In general, the evaporation rate of the solvent should allow for the time required for alignment and arrangement of the nanoparticles, while the viscosity should allow for controlled alignment and migration of the nanoparticles with limited aggregation under a magnetic field. A solvent with suitable viscosity will keep the nanoparticles in solution but also allow the nanoparticles to move. If the solvent is too thin, the paramagnetic nanoparticles can be pushed too far too fast, reducing the ability to fine tune separation and potentially causing aggregation of the paramagnetic nanoparticles. Suitable solvents can include but are not limited to polar solvents with low boiling point and low viscosity. Examples of suitable solvents may include dichloromethane, dimethylformamide, chloroform, N-Methyl-2-pyrrolidone, etc.

In another embodiment, the paramagnetic nanoparticle solution can be deposited on an anodisc support to form a free-standing nanomaterial membrane. The paramagnetic nanoparticle is dispersed in a suitable solvent. The mixture is then placed on a vacuum filtration unit with the anodisc support. The vacuum pull assists the paramagnetic particle deposition downward on the support. Meanwhile, the magnetic field can be applied to control the channel size. In the hollow fiber configuration, a conventional membrane fabrication spinneret is followed by a magnetic field to assist particle alignment within the fiber structure.

The paramagnetic nanoparticle solution can be cast or otherwise deposited on a support disposed in an external magnetic field, which is configured to control deposition of the paramagnetic nanoparticles. In one embodiment, the support can comprise a moveable platform configured to vary a position of the deposited paramagnetic nanoparticle solution and a magnetic flux through the deposited paramagnetic nanoparticle solution. In one non-limiting embodiment, a first magnet can be provided on a bottom of the platform opposite the deposited paramagnetic nanoparticle solution and a second magnet can be provided above the deposited paramagnetic nanoparticle solution such that the deposited paramagnetic nanoparticle solution is disposed between the first and second magnet and the magnetic field can be modified by moving the platform toward and away from the second magnet. In other embodiments described further herein, magnets can be disposed on opposite ends of the deposited paramagnetic nanoparticle solution to orient the paramagnetic nanoparticles parallel to a surface of the resulting membrane. The paramagnetic nanoparticle solution can be deposited under low magnetic field to guide the deposition and orientation of the nanoparticles.

The nanoparticles can be aligned in step 14A by depositing the magnet-activatable nanoparticle solution (e.g., via drop casting or other deposition method) under low magnetic field, for example, set by the separation distance between the first and second magnets. The initial separation between the first and second magnets can be selected to provide a magnetic flux capable of aligning the nanoparticles in solution, while contributing to a lesser extent, to nanoparticle spacing. When the external magnetic field is applied, the nanoparticles themselves experience magnetism, creating their own north and south poles. The aligned nanoparticles can have a vertical orientation (perpendicular to the first and second magnets) relative to a surface of the resulting membrane with oppositely disposed north and south poles. In other embodiments, the aligned nanoparticles can have a horizontal orientation, arranged parallel to the surface of the resulting membrane. In some embodiments, vibration (e.g., ultrasonic vibration can be applied via external probe to the platform) can be applied to the deposited solution to facilitate separation and alignment of the nanoparticles and to reduce the formation of aggregates.

In step 14B, the spacing of the nanoparticles can be modified by changing the magnetic field. The magnetic field can be changed by moving the platform toward or away from the second magnet and thereby changing the separation distance between the first and second magnets. The magnetic field increases when the distance between the first and second magnets is reduced and decreases when the distance between the first and second magnets is increased. The magnetic flux can be measured using a Hall effect sensor. Increasing the magnetic field decreases the distance between adjacent nanoparticles, while reducing the magnetic field increases the distance between adjacent nanoparticles.

Changes in spacing can occur between ends of adjacent nanoparticles and sides of adjacent nanoparticles. Controlling the external magnetic field controls the interparticle repulsion of the poles and, consequently, controls the size of nanochannels through the separation membrane. The distance between adjacent nanoparticles determines the selectivity of the separation membrane. In a non-limiting embodiment, a suitable magnetic flux for aligning nanoparticles and spacing nanoparticles can range from 0.3 to 0.8 Tesla. It will be understood by one of ordinary skill in the art that this range may vary according to the application. Furthermore, the method of applying a magnetic field to the paramagnetic nanoparticle solution is not limited to disposing the paramagnetic nanoparticle solution between magnets. In alternative embodiments, including large-scale commercial production of separation membranes, the magnetic field may be generated, for example, by a Tesla coil.

A further reduction in spacing between adjacent nanoparticles can occur as the solvent evaporates, however, the effect of gravitational settling may be negligible in comparison to the effect of the magnetic field. The paramagnetic nanoparticles can be settled prior to placing the paramagnetic nanoparticle solution in the magnetic field and evaporating the solvent. The evaporation rate of the solvent can be low enough to maintain the polymer presence between adjacent nanoparticles. The final magnetic field can be kept constant until the nanoparticles are fixed in the polymer matrix or dried as a free-standing membrane on a support. Once dried, the orientation and spacing of the nanoparticles is fixed and is retained upon use of the separation membrane.

The pore size or distance between nanoparticles can be measured indirectly though gas or liquid permeation tests. For example, an approximate pore size can be determined by passing or attempting to pass gases of differing radii (e.g., N₂, CO₂, CH₄) through the membrane or molecules of different sizes through the membrane. The measured pore size can be correlated with the magnetic flux measured in the fabrication of the separation membrane.

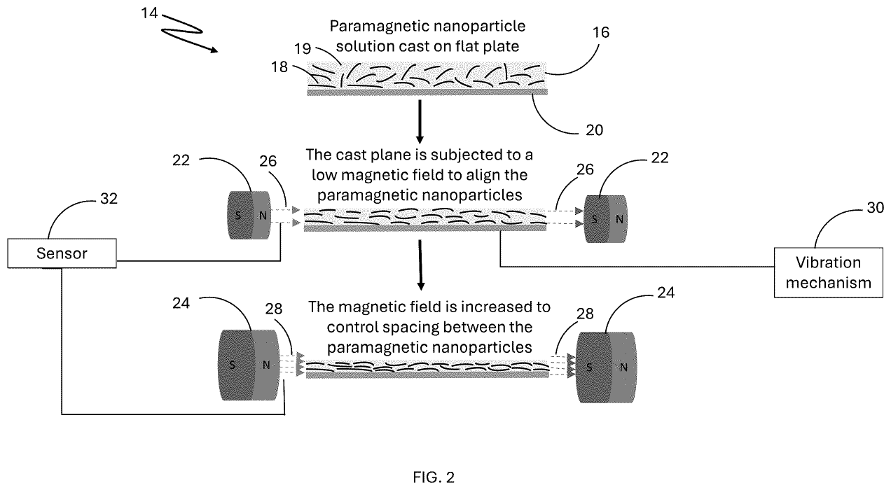

FIG. 2 is a schematic illustration of step 14 of method 10. FIG. 2 shows paramagnetic nanoparticle solution 16, paramagnetic nanoparticles 18, polymer matrix 19 plate 20, magnets 22 and 24, magnetic fields 26 and 28, ultrasound vibration 30 and sensor 32. As previously described, paramagnetic nanoparticle solution 16 can be cast by one of a variety of methods on plate 20. Paramagnetic nanoparticle solution 16 includes paramagnetic nanoparticles 18 dispersed in polymer matrix 19. The cast paramagnetic nanoparticle solution 16 is placed in a low magnetic field 26 (e.g., 0.3 Tesla) to align paramagnetic nanoparticles 18. Magnetic field 26 can be measured by sensor 32 (e.g., Hall effect sensor). As shown in FIG. 2, magnets 22 can be disposed adjacent ends of plate 20 to align paramagnetic nanoparticles in a horizontal orientation parallel to plate 20. Magnets 22 can have north and south poles, which can be arranged such that a north pole of one magnet 22 faces plate 20 and a south pole of the opposite magnet 22 faces plate 20. North and south poles of paramagnetic nanoparticles 18 align with respective south and north poles of magnets 22. Vibration can be applied to paramagnetic nanoparticle solution 16 by vibration mechanism 30. Vibration mechanism 30 can be, for example, an ultrasonic probe positioned in contact with plate 20. Vibration can facilitate dispersion and alignment of paramagnetic nanoparticles 18.

An increased magnetic field 28 can be applied to paramagnetic nanoparticle solution 16 following alignment of paramagnetic nanoparticles 18. The increased magnetic field 28 can be applied by disposing plate 20 with cast paramagnetic nanoparticle solution 16 between larger or stronger magnets 24 or by moving magnets (e.g., magnets 22) closer together. With increasing magnetic field 28 the attraction between the paramagnetic nanoparticles increases, creating a control over nanochannels formed therebetween. Magnetic field 28 can be modified (increased or decreased) to obtain a desired nanoparticle spacing. Magnetic field 28 can be measured by sensor 32.

In other embodiments, magnets may be disposed above and below plate 20 to align paramagnetic nanoparticles in a vertical orientation perpendicular to plate 20. In yet another embodiment, the external magnetic field may be applied via Tesla coil.

The disclosed methods and materials can be used in the fabrication of separation membranes with tunable selectivity for separation of a specific molecule or combinations of molecules of interest. Use of paramagnetic 2D nanoparticles can produce highly controlled and selective membranes for a wide range of applications. Alignment and controlled spacing of the paramagnetic nanoparticles when disposed in an adjustable magnetic field can provide desired interparticle gaps that act as selective channels, capable of effectively filtering out undesirable molecules. The disclosed tunable separation membranes are usable with liquids, gases, and liquid-gas mixtures.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

Any relative terms or terms of degree used herein, such as “substantially”, “essentially”, “generally”, “approximately” and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, transient alignment or shape variations induced by thermal, rotational or vibrational operational conditions, and the like. Moreover, any relative terms or terms of degree used herein should be interpreted to encompass a range that expressly includes the designated quality, characteristic, parameter or value, without variation, as if no qualifying relative term or term of degree were utilized in the given disclosure or recitation.

### DISCUSSION OF POSSIBLE EMBODIMENTS

The following are non-exclusive descriptions of possible embodiments of the present invention.

A separation membrane includes a polymer and a plurality of nanoparticles having magnetic when placed in an external magnetic field, the relative arrangement of the plurality of nanoparticles determining the selectivity of the separation membrane.

The separation membrane of the preceding paragraph can optionally include, additionally and/or alternatively, any one or more of the following features, configurations and/or additional components:

In an embodiment of the separation membrane of the preceding paragraphs, the plurality of nanoparticles comprise two-dimensional materials.

In an embodiment of the separation membrane of any of the preceding paragraphs, the plurality of nanoparticles can be graphene oxide.

In an embodiment of the separation membrane of any of the preceding paragraphs, the plurality of nanoparticles can be a MXene.

In an embodiment of the separation membrane of any of the preceding paragraphs, the plurality of nanoparticles can be intercalated with paramagnetic ions.

In an embodiment of the separation membrane of any of the preceding paragraphs, the plurality of nanoparticles can be intercalated with holmium ions.

In an embodiment of the separation membrane of any of the preceding paragraphs, the plurality of nanoparticles can be intercalated with yttrium ions.

In an embodiment of the separation membrane of any of the preceding paragraphs, the plurality of nanoparticles can be intercalated with a paramagnetic material.

In an embodiment of the separation membrane of any of the preceding paragraphs, the plurality of nanoparticles can be aligned in a vertical or horizontal orientation.

A method of fabricating a separation membrane includes intercalating a plurality of nanoparticles with paramagnetic or magnetic ions or molecules to produce intercalated nanoparticles having magnetic properties, depositing a solution of the plurality of intercalated nanoparticles on a support, applying an external magnetic field to the deposited solution of intercalated nanoparticles, and drying the solution of intercalated nanoparticles.

The method of the preceding paragraph can optionally include, additionally and/or alternatively, any one or more of the following features, configurations, additional components, and/or steps:

In an embodiment of the method of the preceding paragraph, intercalating the plurality of nanoparticles can include swelling the plurality of nanoparticles in a paramagnetic ion salt solution.

In an embodiment of the method of any of the preceding paragraphs, the paramagnetic ion salt solution can include holmium.

In an embodiment of the method of any of the preceding paragraphs, the paramagnetic ion salt solution can include yttrium.

In an embodiment of the method of any of the preceding paragraphs, the plurality of nanoparticles can be graphene oxide.

In an embodiment of the method of any of the preceding paragraphs, the plurality of nanoparticles can be MXenes.

In an embodiment of the method of any of the preceding paragraphs, applying the external magnetic field to the deposited solution of intercalated nanoparticles can align the plurality of intercalated nanoparticles.

In an embodiment of the method of any of the preceding paragraphs, the support can be disposed between two magnets and wherein a strength of the external magnetic field is changed by increasing or decreasing a separation distance between the two magnets.

An embodiment of the method of any of the preceding paragraphs can further include comprising controlling a spacing between adjacent nanoparticles of the plurality of intercalated nanoparticles by increasing or decreasing a strength of the external magnetic field.

In an embodiment of the method of any of the preceding paragraphs, reducing the strength of the external magnetic field reduces a spacing between adjacent intercalated nanoparticles.

In an embodiment of the method of any of the preceding paragraphs, the solution can be deposited by drop casting on a support.

In an embodiment of the method of any of the preceding paragraphs, the solution can include the plurality of intercalated nanoparticles, a polymer, and a solvent.

In an embodiment of the method of any of the preceding paragraphs, the solvent can be dichloromethane.

In an embodiment of the method of any of the preceding paragraphs, the polymer can be a gas permeable polymer.

1. A separation membrane comprising:
a polymer; and
a plurality of nanoparticles having magnetic properties, the relative arrangement of the plurality of nanoparticles determining the selectivity of the separation membrane.

2. The separation membrane of claim 1, wherein the plurality of nanoparticles comprise two-dimensional materials.

3. The separation membrane of claim 2, wherein the plurality of nanoparticles comprise graphene oxide.

4. The separation membrane of claim 2, wherein the plurality of nanoparticles comprise a MXene.

5. The separation membrane of claim 2, wherein the plurality of nanoparticles are intercalated with paramagnetic ions.

6. The separation membrane of claim 5, wherein the plurality of nanoparticles are intercalated with holmium ions.

7. The separation membrane of claim 5, wherein the plurality of nanoparticles are intercalated with yttrium ions.

8. The separation membrane of claim 2, wherein the plurality of nanoparticles are intercalated with a paramagnetic material.

9. The separation membrane of claim 2, wherein the plurality of nanoparticles are aligned in a vertical or horizontal orientation.

10. A method of fabricating a separation membrane, the method comprising:
intercalating a plurality of nanoparticles with paramagnetic ions or paramagnetic molecules to produce intercalated nanoparticles having magnetic properties;
depositing a solution of the plurality of intercalated nanoparticles on a support;
applying an external magnetic field to the deposited solution of intercalated nanoparticles; and
drying the solution of intercalated nanoparticles.

11. The method of claim 10, wherein intercalating the plurality of nanoparticles comprises swelling the plurality of nanoparticles in a paramagnetic ion salt solution.

12. The method of claim 11, wherein the paramagnetic ion salt solution comprises holmium.

13. The method of claim 11, wherein the paramagnetic ion salt solution comprises yttrium.

14. The method of claim 10, wherein the plurality of nanoparticles are graphene oxide.

15. The method of claim 10, wherein the plurality of nanoparticles are MXenes.

16. The method of claim 10, wherein applying the external magnetic field to the deposited solution of intercalated nanoparticles aligns the plurality of intercalated nanoparticles.

17. The method of claim 10, wherein the support is disposed between two magnets and wherein a strength of the external magnetic field is changed by increasing or decreasing a separation distance between the two magnets.

18. The method of claim 10 and further comprising controlling a spacing between adjacent nanoparticles of the plurality of intercalated nanoparticles by increasing or decreasing a strength of the external magnetic field.

19. The method of claim 18, wherein reducing the strength of the external magnetic field reduces a spacing between adjacent intercalated nanoparticles.

20. The method of claim 10, wherein the solution is deposited by drop casting on a support.

21. The method of claim 10, wherein the solution comprises the plurality of intercalated nanoparticles, a polymer, and a solvent.

22. The method of claim 21, wherein the solvent is dichloromethane.

23. The method of claim 22, wherein the polymer is a gas permeable polymer.
